(19) United States
(12) Patent Application Publication
(10) Pub. No.: US 2011/0141593 A1
(43) Pub. Date: Jun. 16, 2011

(54) METHOD AND APPARATUS FOR AVOIDING A COLLISION OF AN OBJECT WITH A FIRST VEHICLE DOOR OF A STATIONARY VEHICLE

(75) Inventors: Torsten KANNING, Eltville-Erbach (DE); Justus ILLIUM, Mainz (DE)

(73) Assignee: GM GLOBAL TECHNOLOGY OPERATIONS, INC., Detroit, MI (US)

(21) Appl. No.: 12/904,899

(22) Filed: Oct. 14, 2010

(30) Foreign Application Priority Data
Oct. 14, 2009 (DE) 102009049368.9

(51) Int. Cl. B60R 1/072

(52) U.S. Cl. 359/843

(57) ABSTRACT

A method and apparatus are provided for avoidance of a possible collision of an object with a first vehicle door of a stationary vehicle. The method includes, but is not limited to determining at least one first parameter of the vehicle, with the first parameter characterizing the stationary state of the vehicle. In addition, a first outside mirror of the vehicle is displaced from a first position into a second position. The first outside mirror in the second position makes a first dead angle region of the vehicle substantially visible for a first vehicle occupant. The first outside mirror is disposed on the same vehicle side as the first vehicle door. Furthermore, at least one second parameter of the vehicle is determined and the first outside mirror is displaced from the second position into the first position.

### CROSS-REFERENCE TO RELATED APPLICATION

This application claims priority to German Patent Application No. 102009049368.9, filed Oct. 14, 2009, which is incorporated herein by reference in its entirety.

### TECHNICAL FIELD

The technical field relates to a method and an apparatus for avoiding a possible collision of an object with a first vehicle door of a stationary vehicle.

### BACKGROUND

A method and an apparatus for warning of a door collision in a motor vehicle are known from DE 102 61 222 A1. In this case, a method for warning a driver of a stationary motor vehicle of a possible collision of an object with a vehicle door of the motor vehicle comprises the steps: monitoring at least the driver's side lateral back space having a predefined width and depth, detecting an object in the lateral back space to be monitored, determining the distance and the speed of the detected object, calculating a warning distance as a function of the object speed and a predefined total reaction time and outputting a warning signal if the object distance is shorter than the warning distance. The method is relatively complex, with the result that the apparatus requires numerous components.

It is at least one object to provide a method and an apparatus for avoiding a possible collision of an object with a first vehicle door of a stationary vehicle. The method can be implemented as simply as possible and the apparatus requires as few components as possible.

### SUMMARY

A method is provided for avoidance of a possible collision of an object with a first vehicle door of a stationary vehicle. At least one first parameter of the vehicle is determined. The first parameter characterizes the stationary state of the vehicle. In addition, a first outside mirror of the vehicle is displaced from a first position into a second position. The first outside mirror in the second position makes a first dead angle region of the vehicle substantially visible for a first vehicle occupant. The first outside mirror is disposed on the same vehicle side as the first vehicle door. Furthermore, at least one second parameter of the vehicle is determined and the first outside mirror is displaced from the second position into the first position.

By displacing the first outside mirror from the first position into the second position, in which the outside mirror makes the first dead angle region of the vehicle substantially visible for the first vehicle occupant, the method makes it possible to reliably avoid a possible collision of the object with the first vehicle door. The method has at least the advantage here that it can be implemented very simply by displacing the first outside mirror after determining the first parameter. In addition, by determining the second parameter and displacing the first outside mirror from the second position into the first position after determining the second parameter, the method additionally has at least the advantage that in the event of a possible renewed approach of the vehicle, the outside mirror is ready again in the original position and consequently makes a favorable region of the back space for driving of the vehicle visible to the vehicle occupant.

A dead angle region is understood here and subsequently to mean a region to the side and behind the vehicle, which as a result of the restricted field of view of the vehicle occupant and the geometrical relationships at the vehicle, cannot be viewed without an appreciable change in the field of view by turning the head of the vehicle occupant. This therefore comprises a region at the side of the vehicle and behind the vehicle which is poorly visible or barely visible, wherein this region can vary according to the size and seat position of the vehicle occupant.

In a preferred embodiment of the method, the first parameter is a switching-off of the ignition of the vehicle. This makes it possible to reliably identify the stationary state of the vehicle. Furthermore, the first parameter can be a switching of the vehicle to idling. This also makes it possible to identify the stationary state of the vehicle.

In a preferred embodiment, the second parameter is a locking of the vehicle. In addition, the second parameter can be a closing of the first vehicle door, wherein the closing of the first vehicle door can be determined by means of a door contact switch. In addition, the second parameter can be a predetermined time after determining the first parameter. The embodiments advantageously make it possible to identify that the vehicle occupant has left the vehicle.

In a further preferred embodiment of the method, at least one third parameter of the vehicle is determined. The third parameter characterizes the possible leaving of the vehicle by the first vehicle occupant. The displacement of the first outside mirror from the first position into the second position then takes place depending on the third parameter. This embodiment has the advantage that by determining the third parameter, which characterizes the possible leaving of the vehicle by the vehicle occupant, and by displacing the first outside mirror into the second position depending on the third parameter, an unnecessary displacement of the outside mirror can be avoided with the result that the lifetime of the outside mirror or a displacement apparatus for displacing the outside mirror can advantageously be increased.

In this case, the third parameter can be an occupation of a seat of the vehicle by the first vehicle occupant. The occupation of the seat can be determined by means of a seat occupation mat. In addition, the third parameter can be an approach of the first vehicle occupant to the first vehicle door, wherein the approach can be determined by means of a proximity sensor. Furthermore, the third parameter can be a release of a belt lock. It is also possible that the third parameter is an opening of the first vehicle door, wherein the opening of the first vehicle door can be determined by means of a door contact switch. The embodiments are particularly suitable for identifying a possible leaving of the vehicle by the vehicle occupant.

In a further preferred embodiment, the second position is a predetermined position. As a result, the method is further simplified in an advantageous manner since merely one specified position is provided for the second position.

In an alternative preferred embodiment, the second position can be preselected by the first vehicle occupant. As a result, the method certainly becomes slightly more complex but advantageously enables the second position to be individually adapted to the vehicle occupant, with the result that a safe viewing of the dead angle region by the vehicle occupant can be ensured to a further increased extent.

The vehicle occupant can be a driver or a passenger. The object can in particular be a bicycle and/or a person. In this case, the bicycle or the person can approach the stationary vehicle from behind.

In a further embodiment of the method, a second outside mirror of the vehicle is displaced from a third position into a fourth position after determining the at least one first parameter of the vehicle. The second outside mirror in the fourth position makes a second dead angle region of the vehicle substantially visible for a second vehicle occupant and is disposed on the same vehicle side as a second vehicle door. In addition, the second outside mirror is displaced from the fourth position into the third position after determining the at least one second parameter of the vehicle.

This embodiment advantageously makes it possible for the second vehicle occupant to safely get out of the vehicle since a possible collision of an object with the second vehicle door can be avoided by making the second dead angle region visible for the second vehicle occupant. In addition, by displacing the second outside mirror from the fourth position into the third position after determining the second parameter, in the event of a possible renewed approach of the vehicle, the previously adjusted position of the second outside mirror is again provided so that a corresponding relevant region to the side of and behind the vehicle is made visible during the driving of the vehicle.

The vehicle is preferably a motor vehicle, in particular a passenger automobile.

The invention further relates to an apparatus for avoidance of a possible collision of an object with a first vehicle door of a stationary vehicle. The apparatus is configured to carry out a method according to any one of the preceding embodiments.

Since the apparatus is configured to carry out one of the aforesaid methods, it advantageously has a small number of required components, since the methods as already explained above are simple to carry out.

### BRIEF DESCRIPTION OF THE DRAWINGS

The present invention will hereinafter be described in conjunction with the following drawing figures, wherein like numerals denote like elements, and

FIG. 1 shows a flow diagram of a method for avoidance of a possible collision of an object with a first vehicle door of a stationary vehicle according to one embodiment of the invention;

FIG. 2 shows a stationary vehicle with an apparatus for avoidance of a possible collision of an object with a first vehicle door of the vehicle according to one embodiment of the invention; and

FIG. 3 shows an apparatus for avoidance of a possible collision of an object with the first vehicle door of the stationary vehicle according to one embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

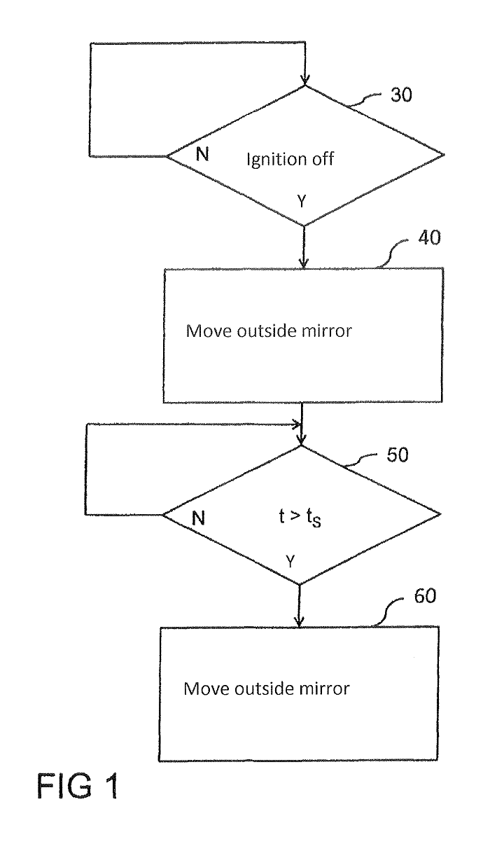

FIG. 1 shows a flow diagram of a method for avoidance of a possible collision of an object with a first vehicle door of a stationary vehicle according to one embodiment of the invention;

In this case, in a first step 30 at least one first parameter of the vehicle is determined, the first parameter characterizing the stationary state of the vehicle. In the embodiment shown, the first parameter is the switching off of the vehicle ignition. If the ignition is not switched off, this step 30 is repeated. If the vehicle ignition is switched off, in a step 40 a first outside mirror of the vehicle is displaced from a first position into a second position. In the second position the first outside mirror makes a first dead angle region of the vehicle substantially visible for a first vehicle occupant. The first outside mirror is disposed on the same vehicle side as the first vehicle door.

In a step 50, at least one second parameter of the vehicle is determined. In the embodiment shown, the second parameter is a predetermined time tₛ after determining the first parameter. If the time t after determining the first parameter is shorter than or equal to the predetermined time tₛ, the step 50 is repeated. If the time t is greater than the predetermined time tₛ, in a step 60, the first outside mirror is displaced from the second position into the first position.

The embodiments start from the consideration that when getting out of the vehicle, it can frequently occur that pedestrians or in the worst case, approaching cyclists are overlooked. When getting out, the driver or passenger is not always in a position to rapidly and simply identify the surroundings outside the vehicle or approaching dangers. After stopping the vehicle, the outside mirror is displaced into a corresponding position, in which the driver and/or the passenger can better identify sources of danger approaching the vehicle from behind in order to avoid accidents. The passenger and/or the driver is thereby assisted when getting out. After switching off the ignition, in the embodiment shown the first outside mirror is automatically displaced into a correspondingly predetermined position, which in Cartesian coordinates can be characterized by the variables X and Y in order to signal approaching sources of danger to the driver and/or the passenger by means of the outside mirror. It is also possible that the first outside mirror and a second outside mirror, i.e., both outside mirrors of the vehicle, are automatically displaced into corresponding predetermined positions. In the embodiment shown, after the predetermined time tₛ has been exceeded, the first outside mirror is automatically moved back into the previous position in the form of the first position. It is also possible that the mirror is displaced into the previous position after leaving the vehicle or locking the vehicle. In addition, both outside mirrors can be moved back into the previous positions after leaving the vehicle or locking the vehicle or exceeding the predetermined time tₛ. The method consequently allows the passenger and/or driver to get out safely after parking the vehicle.

In a further embodiment, between steps 30 and 40 at least a third parameter of the vehicle is determined, the third parameter characterizing the possible leaving of the vehicle by the first vehicle occupant. The first outside mirror is then displaced from the first position into the second position in step 40 depending on the third parameter. This embodiment starts from the consideration that the corresponding outside mirror should only be moved specifically and not unnecessarily in order to increase its lifetime or the lifetime of an apparatus required for the displacement. The outside mirror can be controlled by detecting the occupancy of a seat. This applies to the driver and/or passenger seat. The occupancy can be detected by means of a seat occupation mat. In addition, the control can be accomplished by means of a proximity sensor, which determines an approach of the vehicle occupant to the vehicle door. The proximity sensor can be configured in the form of a motion sensor integrated in a door handle. In addition, the outside mirror can be controlled in conjunction with a release of a belt lock or in conjunction with a door contact switch. The door contact switch can be integrated in the door lock and can determine an opening of the vehicle door. In addition, the door contact switch can be provided for further functions, for example, for controlling an interior lighting of the vehicle or for a door open indication.

In further exemplary embodiments, the displacement of the outside mirror from the second position into the first position and/or a deactivation can also take place by means of the door contact switch, the door contact switch determining a closure of the vehicle door. In addition, the locking and/or the deactivation can take place by means of a locking command, for example, a central locking, or, as shown above, it can be time-controlled.

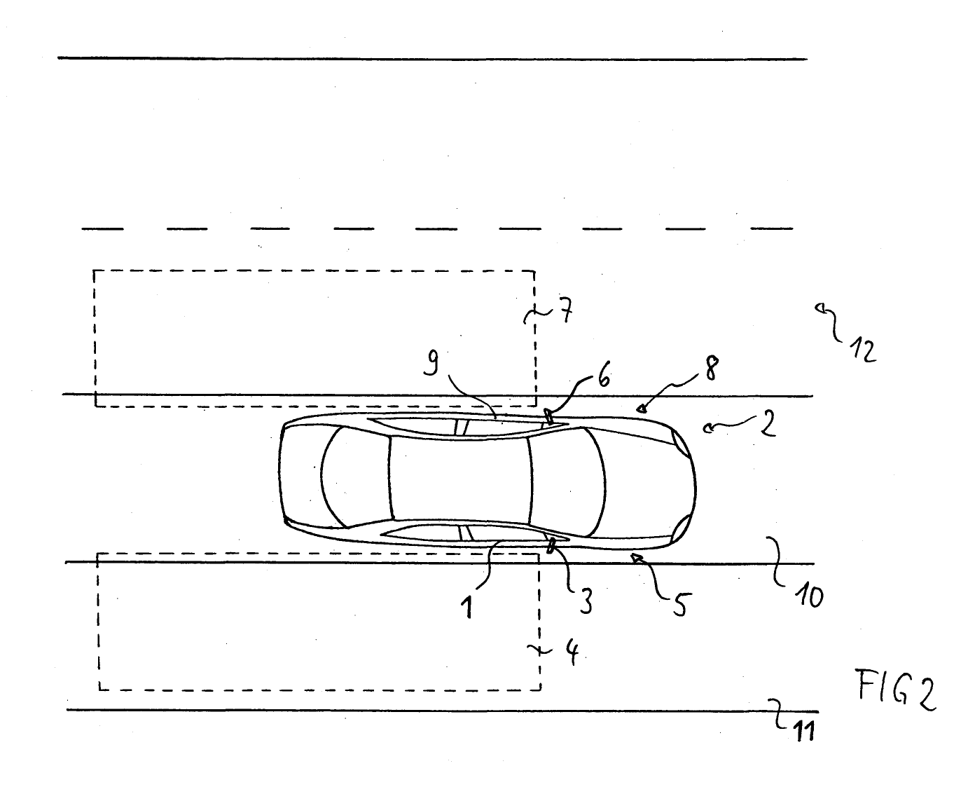

FIG. 2 shows a stationary vehicle 2 with an apparatus, not shown in detail, for avoidance of a possible collision of an object with a first vehicle door 1 of the vehicle 2 according to one embodiment. The apparatus for avoidance of collisions will be shown in further detail in the following figure and explained.

The vehicle 2 is parked on a shoulder 10 adjoining a roadway 12. On the side of the vehicle 2 opposite the roadway 12, there is a bicycle lane 11. On this bicycle lane 11 a cyclist not shown can approach the vehicle 2 from behind. In addition, a vehicle, not shown, can approach the vehicle 2 from behind on the roadway 12.

In addition, FIG. 2 shows schematically with the aid of dashed lines a first dead-angle region 4 and a second dead-angle region 7 of the vehicle 2. If a cyclist is located in the first dead-angle region 4 and/or a vehicle is located in the second dead-angle region 7, these can only be poorly identified by a first vehicle occupant and/or by a second vehicle occupant, for example, a passenger or a driver.

With the aid of the apparatus for avoidance of a possible collision of an object with the first vehicle door 1 and/or a second vehicle door 9 of the stationary vehicle 2, shown in further detail in the following figure, it is possible for passenger and/or driver to get out safely after parking the vehicle 2, whereby accidents can be avoided.

For this purpose, a first outside mirror 3 of the vehicle 2 is displaced from a first position into a second position and/or a second outside mirror 6 of the vehicle 2 is displaced from a third position into a fourth position, the first outside mirror 3 in the second position making the first dead angle region 4 of the vehicle 2 substantially visible for the first vehicle occupant, for example, the passenger and the second outside mirror 6 in the fourth position making the second dead angle region 7 of the vehicle 2 substantially visible for the second vehicle occupant, for example, the driver. In this case, the first outside mirror 3 is disposed on the same lateral vehicle side 5 as the first vehicle door 1 and the second outside mirror 6 is disposed on the same lateral vehicle side 8 as the second lateral vehicle door 9.

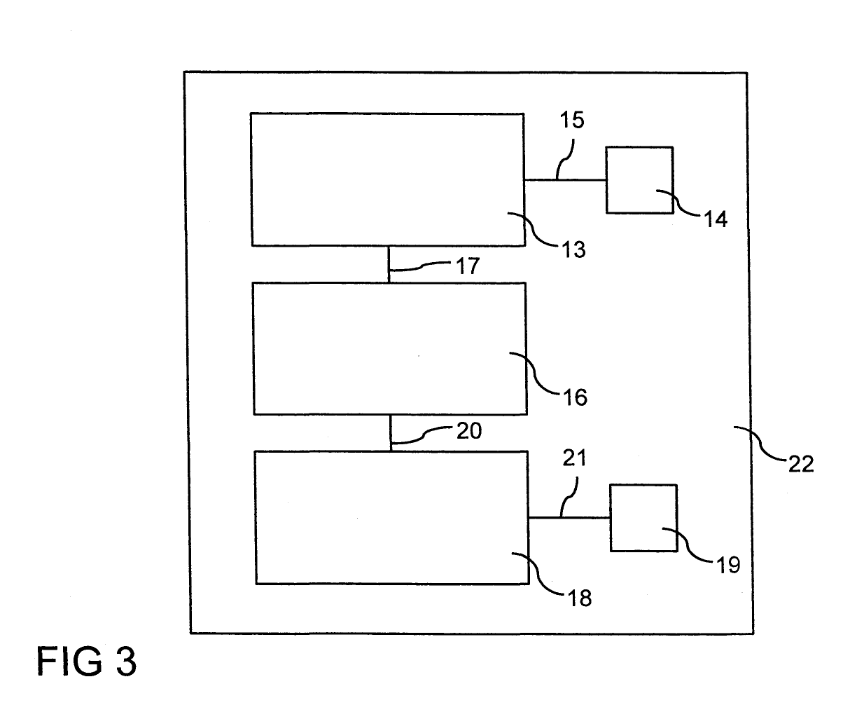

FIG. 3 shows an apparatus 22 for avoidance of a possible collision of an object with the first vehicle door, not shown in detail in FIG. 3, of the stationary vehicle according to one embodiment.

The apparatus 22 comprises a first determination apparatus 13, the first determination apparatus 13 being configured to determine at least one first parameter of the vehicle. The first parameter in this case characterizes the stationary state of the vehicle. To this end, the first determination apparatus 13 is connected to a first sensor 14 via a signal line 15. In addition, the apparatus 22 comprises a second determination apparatus 18, the second determination apparatus 18 being configured to determine at least one second parameter of the vehicle. To this end, the second determination apparatus 18 is connected to a second sensor 19 via a signal line 21.

Furthermore, the apparatus 22 has a displacement apparatus 16, the displacement apparatus 16 being configured to displace the first outside mirror of the vehicle from the first position into the second position and/or for displacing the second outside mirror of the vehicle from the third position into the fourth position and back in each case. The displacement apparatus 16 is connected to the first determination apparatus 13 via a control line 17 and to the second determination apparatus 18 via a control line 20. The control lines 17 and 20 can be a component part of a CAN bus, at least in parts. In the embodiment shown, the first determination apparatus 13 determines a switching off of the vehicle ignition. If the first determination apparatus 13 has determined such a switching-off of the vehicle ignition, the displacement apparatus 16 is triggered via the control line 17 and this displaces the first outside mirror from the first position into the second position and/or the second outside mirror from the third position into the fourth position.

In the embodiment shown, the second determination apparatus 18 determines a locking of the vehicle. If a corresponding locking of the vehicle, for example, by means of a central locking is made, the second determination apparatus 18 triggers the displacement apparatus 16 via the control line 20 and this displaces the first outside mirror from the second position back into the first position and/or the second outside mirror from the fourth position back into the third position.

The apparatus 22 makes it possible to implement a method for avoidance of a possible collision of an object with the first vehicle door and/or the second vehicle door in the vehicle.

In the embodiment shown, the vehicle 2 is a motor vehicle in the form of a passenger automobile.

The second position and/or the fourth position can be a predetermined position or can be preselected by the first vehicle occupant and/or the second vehicle occupant. In this case, the preselected position can be stored, in particular in a personalization menu, for example, in a seat memory, of the vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1-15. (canceled)

16. A method for avoidance of a possible collision of an object with a first vehicle door of a vehicle, the method comprising:
determining at least a first parameter of the vehicle that characterizes a stationary state of the vehicle;
displacing a first outside mirror of the vehicle from a first position into a second position,
wherein the first outside mirror in the second position makes a first dead angle region of the vehicle that is substantially visible for a first vehicle occupant, and
wherein the first outside mirror is disposed on a side of the vehicle with the first vehicle door;
determining a second parameter of the vehicle, and
displacing the first outside mirror from the second position into the first position.

17. The method according to claim 16, wherein the vehicle is a stationary vehicle.

18. The method according to claim 16, wherein the first parameter is a switching-off of an ignition of the vehicle.

19. The method according to claim 16, wherein the first parameter is a transfer of the vehicle to an idling.

20. The method according any to claim 16, wherein the second parameter is a locking of the vehicle.

21. The method according to claim 16, wherein the second parameter is a closing of the first vehicle door.

22. The method according to claim 16, wherein the closing of the first vehicle door is determined by a door contact switch.

23. The method according to claim 16, wherein the second parameter is determined a predetermined time after determining the first parameter.

24. The method according to claim 16, further comprising determining a third parameter of the vehicle, wherein the third parameter characterizes a possible leaving of the vehicle by the first vehicle occupant and wherein displacement of the first outside mirror from the first position into the second position takes place depending on the third parameter.

25. The method according to claim 24, wherein the third parameter is an occupation of a seat of the vehicle by the first vehicle occupant.

26. The method according to claim 25, wherein the occupation of the seat is determined by a seat occupation mat.

27. The method according to claim 24, wherein the third parameter is an approach of the first vehicle occupant to the first vehicle door.

28. The method according to claim 27, wherein the approach is determined with a proximity sensor.

29. The method according to claim 24, wherein the third parameter is a release of a belt lock.

30. The method according to claim 24, wherein the third parameter is an opening of the first vehicle door.

31. The method according to claim 30, wherein the opening of the first vehicle door is determined with a door contact switch.

32. The method according to claim 16, wherein the second position is a predetermined position.

33. The method according to claim 16, wherein the second position is preselectable.

34. The method according to claim 16, further comprising:
displacing a second outside mirror of the vehicle from a third position into a fourth position after determining the first parameter of the vehicle,
wherein the second outside mirror in the fourth position makes a second dead angle region of the vehicle that is substantially visible for a second vehicle occupant,
and wherein the second outside mirror is disposed on a side of the vehicle side with a second vehicle door; and
displacing the second outside mirror from the fourth position into the third position after determining the second parameter of the vehicle.

35. An apparatus for avoidance of a possible collision of an object with a first vehicle door of a vehicle, comprising:
a first detector configured to determine at least a first parameter of the vehicle that characterizes a stationary state of the vehicle;
a first outside mirror configured to displace from a first position into a second position,
wherein the first outside mirror in the second position makes a first dead angle region of the vehicle that is substantially visible for a first vehicle occupant, and
wherein the first outside mirror is disposed on a side of the vehicle with the first vehicle door;
a second detector configured to determine a second parameter of the vehicle, and
a displacement mechanism configured to displace the first outside mirror from the second position into the first position.

36. The apparatus according to claim 35, wherein the vehicle is a stationary vehicle.

37. The apparatus according to claim 35, wherein the first parameter is a switching-off of an ignition of the vehicle.

38. The apparatus according to claim 35, wherein the first parameter is a transfer of the vehicle to an idling.

39. The apparatus according any to claim 35, wherein the second parameter is a locking of the vehicle.

40. The apparatus according to claim 35, wherein the second parameter is a closing of the first vehicle door.

41. The apparatus according to claim 35, further comprising a door contact switch configured to determine the closing of the first vehicle door.

42. The apparatus according to claim 35, wherein the second parameter is determined a predetermined time after determining the first parameter.

43. The apparatus according to claim 35, further comprising a third detector configured to determine a third parameter of the vehicle, wherein the third parameter characterizes a possible leaving of the vehicle by the first vehicle occupant and wherein displacement of the first outside mirror from the first position into the second position takes place depending on the third parameter.

44. The apparatus according to claim 43, wherein the third parameter is an occupation of a seat of the vehicle by the first vehicle occupant.

45. The apparatus according to claim 44, further comprising a seat occupation mat configured to determine the occupation of the seat.

46. The apparatus according to claim 43, wherein the third parameter is an approach of the first vehicle occupant to the first vehicle door.

47. The apparatus according to claim 46, further comprising a proximity sensor configured to the approach.

48. The apparatus according to claim 43, wherein the third parameter is a release of a belt lock.

49. The apparatus according to claim 43, wherein the third parameter is an opening of the first vehicle door.

50. The apparatus according to claim 49, further comprising a door contact switch configured to determine the opening of the first vehicle door.

51. The method according to claim 35, further comprising:
a second outside mirror of the vehicle configured to displace from a third position into a fourth position after determining the first parameter of the vehicle,
wherein the second outside mirror in the fourth position makes a second dead angle region of the vehicle substantially visible for a second vehicle occupant,
and wherein the second outside mirror is disposed on the same vehicle side as a second vehicle door; and
a second displacement mechanism configured to displace the second outside mirror from the fourth position into the third position after determining the second parameter of the vehicle.
